(19) United States
(12) Patent Application Publication
(10) Pub. No.: US 2019/0393686 A1
(43) Pub. Date: Dec. 26, 2019

(54) WIRE HARNESS

(71) Applicant: SUMITOMO WIRING SYSTEMS, LTD., Yokkaichi-shi, Mie (JP)

(72) Inventor: Yuya HIROMORI, Yokkaichi (JP)

(73) Assignee: SUMITOMO WIRING SYSTEMS, LTD., Yokkaichi-shi, Mie (JP)

(21) Appl. No.: 16/480,724

(22) PCT Filed: Jan. 16, 2018
(86) PCT No.: PCT/JP2018/000995

§ 371 Date: Jul. 25, 2019

(30) Foreign Application Priority Data
Jan. 25, 2017 (JP) 2017-011300

(51) Int. Cl. H02G 3/04; H02G 1/08

(52) U.S. Cl. CPC H02G 3/0418; B60R 16/0215; H02G 1/08

(57) ABSTRACT

A wire harness includes: a pipe including a first layer that is made of a resin material, and a second layer that is made of a metal material and is provided on an outer side of the first layer; electric wires inserted through the pipe; and a braided member that is formed by braiding a plurality of metal element wires, and is attached to the pipe so as to cover drawn-out portions of the electric wires that are drawn out from the pipe. The wire harness further includes a fitting that is fitted into the pipe and includes an insertion hole through which the electric wires can be inserted, and a fastener for fastening, in a region of the pipe in which the fitting is provided, the braided member to an outer circumferential face of the second layer.

The present disclosure relates to a wire harness. This application is the U.S. National Phase of PCT/JP2018/000995 filed Jan. 16, 2018, which claims priority to JP 2017-011300, filed Jan. 25, 2017, the entire disclosure of which are incorporated by reference.

### BACKGROUND

Wire harnesses that electrically connect batteries and inverters in vehicles such as electric vehicles or hybrid cars are known. These wire harnesses are arranged, for example, under floors or the like of vehicles. A wire harness includes a plurality of electric wires, a pipe covering the plurality of electric wires, a braided member formed by braiding a plurality of metal element wires into a tubular shape, and a fastener for fastening the pipe and the braided member to each other. The plurality of electric wires are drawn out from an end of the pipe to the outside, extend through the braided member, and are connected to a device such as an inverter. The fastener fastens the pipe and the braided member by being crimped with the application of pressure using a tool or the like in a state in which the braided member is held between the fastener and the outer circumferential face of the pipe. JP 2006-311699 discloses an example of a conventional wire harness.

### SUMMARY

In order to firmly fasten a pipe and a braided member to each other, it is preferable to increase a pressure applied to the fastening. On the other hand, if the pressure applied to the fastener is high, the pipe may be deformed due to the pressure that acts on the pipe via the braided member. In this case, the contact area between the pipe and the braided member becomes smaller, and it is not possible to firmly fasten the pipe and the braided member to each other.

Aspects of the present disclosure were made in order to solve these problems, and it is an object thereof to provide a wire harness capable of firmly fastening a pipe and a braided member to each other.

A wire harness that solves the above-described problem is a wire harness including: a pipe including a first layer that is made of a non-conductive material such as a resin material, and a second layer that is made of a metal material and is provided on an outer side of the first layer; electric wires inserted through the pipe; a braided member that is formed by braiding a plurality of metal element wires, and is attached to the pipe so as to cover drawn-out portions of the electric wires that are drawn out from the pipe; a fitting member that is fitted into the pipe and includes an insertion hole through which the electric wires can be inserted; and a fastener for fastening, in a region of the pipe in which the fitting is provided, the braided member to an outer circumferential face of the second layer.

With this configuration, the region of the pipe that is subjected to the pressure applied to the fastening member is supported by the fitting, and thus, even when high pressure is applied to the fastener, the risk that the pipe will be deformed is lowered. Accordingly, it is possible to firmly fasten the pipe and the braided member to each other.

In the above-described wire harness, it is preferable that the fitting is fitted into the pipe so as to block an opening of the pipe.

With this configuration, the region of the pipe that is subjected to the pressure applied to the fastener is supported by the fitting member in a dispersed manner in the circumferential direction of the pipe, and thus the risk that the pipe will be deformed is further lowered. Accordingly, it is possible to more firmly fasten the pipe and the braided member to each other.

In the above-described wire harness, it is preferable that the pipe further includes a third layer that is made of a resin material and is provided on an outer side of the second layer.

With this configuration, the outer layer of the pipe is constituted by a third layer that is made of a resin material, and thus, for example, even when flying rocks come into contact with the wire harness during driving of the vehicle, the wire harness is unlikely to deteriorate.

In the above-described wire harness, it is preferable that the fitting member further includes a main body through which the insertion hole is formed, and a groove that is formed on an outer circumferential face of the main body and extends in a circumferential direction of the pipe.

With this configuration, the pipe is deformed by the pressure that acts on the pipe, and the deformed portion is accommodated in the groove of the fitting member, and thus it is possible to firmly fasten the pipe and the braided member to each other.

In the above-described wire harness, it is preferable that the fastener is, in a region of the pipe in which the fitting member is provided, arranged within a width region in which the groove is formed.

With this configuration, the pipe is deformed by the pressure that acts on the pipe, and the deformed portion is likely to be accommodated in the groove of the fitting member. Accordingly, it is possible to stably fasten the pipe and the braided member to each other.

In the above-described wire harness, it is preferable that a reduced diameter portion is formed in a portion of the pipe that is tightened by the fastener, and part of the reduced diameter portion is formed so as to be accommodated in the groove.

With this configuration, part of the reduced diameter portion deformed by the pressure that acts on the pipe is accommodated in the groove of the fitting member, and thus it is possible to firmly fasten the pipe and the braided member to each other.

In the above-described wire harness, it is preferable that the fitting member further includes a main body through which the insertion hole is formed, and a restricting portion that is provided on the main body and is in contact with an end face of the pipe, thereby restricting movement of the main body in a longitudinal direction of the pipe.

With this configuration, movement of the fitting member in the longitudinal direction of the pipe is restricted by the restricting portion, and thus it is possible to properly determine the position of the fitting member with respect to the pipe.

### Advantageous Effects

According to the wire harness of the preferred embodiments, it is possible to firmly fasten a pipe and a braided member to each other.

### BRIEF DESCRIPTION OF DRAWINGS

FIG. 1 is a schematic view showing an example of a state in which a wire harness according to a first embodiment is arranged.

FIG. 2 is a perspective view of the wire harness in FIG. 1.

FIG. 3 is a cross-sectional view of the wire harness in FIG. 2.

FIG. 4 is a cross-sectional view showing a state before a pipe and a braided member are fastened to each other in a wire harness according to a second embodiment.

FIG. 5 is a cross-sectional view showing a state in which a pipe and a braided member are fastened to each other in the wire harness in FIG. 4.

FIG. 6 is a cross-sectional view of a wire harness according to a third embodiment.

FIG. 7 is a cross-sectional view of a wire harness according to a modified example.

### DESCRIPTION OF EMBODIMENTS

### First Embodiment

Hereinafter, a first embodiment of a wire harness will be described.

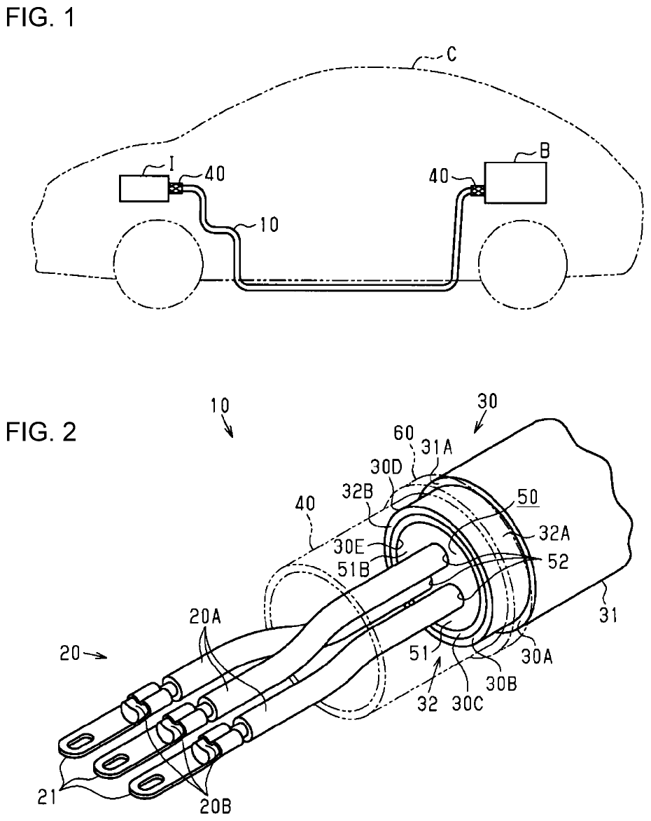

A vehicle C shown in FIG. 1 includes a wire harness 10 for electrically connecting a battery B and an inverter I. The battery B is mounted, for example, in the rear portion of the vehicle C. The inverter I is mounted, for example, in an engine room in the front portion of the vehicle C. Examples of the vehicle C include electric vehicles and hybrid cars. The wire harness 10 is arranged under a floor of the vehicle C, and is bent so as to connect the battery B and the inverter I.

As shown in FIG. 2, the wire harness 10 includes electric wires 20, and a pipe 30 through which the electric wires 20 are inserted. The number of electric wires 20 is, for example, three. The wire harness 10 further includes terminals 21 that are provided respectively at ends 20B of the electric wires 20. The electric wires 20 are drawn out from an end 30D of the pipe 30 to the outside, and are connected via the terminals 21 to an object device. The object device is the battery B or the inverter I (see FIG. 1).

The pipe 30 is a pipe with at least a two-layered structure consisting of an intermediate layer 30B, and an inner layer 30C, a third layer (outer layer 30A) may also be present. The inner layer 30C is a first layer that is made of an electrically non-conductive material, for example, a resin material. The intermediate layer 30B is a second layer that is made of a metal material. Examples of the metal material include aluminum. The intermediate layer 30B is provided on the outer side of the inner layer 30C, and is arranged between the outer layer 30A and the inner layer 30C. The outer layer 30A is a third layer that is made of a resin material. The outer layer 30A is provided on the outer side of the intermediate layer 30B.

The pipe 30 includes a pipe main body 31, and a connecting portion 32 projecting in the longitudinal direction of the pipe main body 31 from an end face 31A of the pipe main body 31. At the connecting portion 32, the outer layer 30A is stripped off to expose the intermediate layer 30B. Examples of the method for stripping off the outer layer 30A include cutting. For example, the connecting portion 32 is formed by stripping off the outer layer 30A by a length corresponding to a predetermined length in the longitudinal direction of the pipe 30, at the end 30D of the pipe 30.

The wire harness 10 further includes a braided member 40 that is formed by braiding a plurality of metal element wires into a tubular shape, a fitting member 50 that is fitted into the pipe 30, and a fastening member/fastener 60 for fastening the pipe 30 and the braided member 40 to each other. The braided member 40 may be, for example, flexible. The braided member 40 is attached to the pipe 30 so as to cover drawn-out portions 20A, of the respective electric wires 20, that are drawn out from the pipe 30. For example, the braided member 40 is attached to an outer circumferential face 32A of the connecting portion 32. The outer circumferential face 32A of the connecting portion 32 is constituted by the outer circumferential face of the intermediate layer 30B. Since the braided member 40 and the intermediate layer 30B made of a metal material are connected to each other, the braided member 40 functions as an electromagnetic shield. The dashed double dotted lines in FIG. 2 indicate the braided member 40 and the fastening member (fastener) 60.

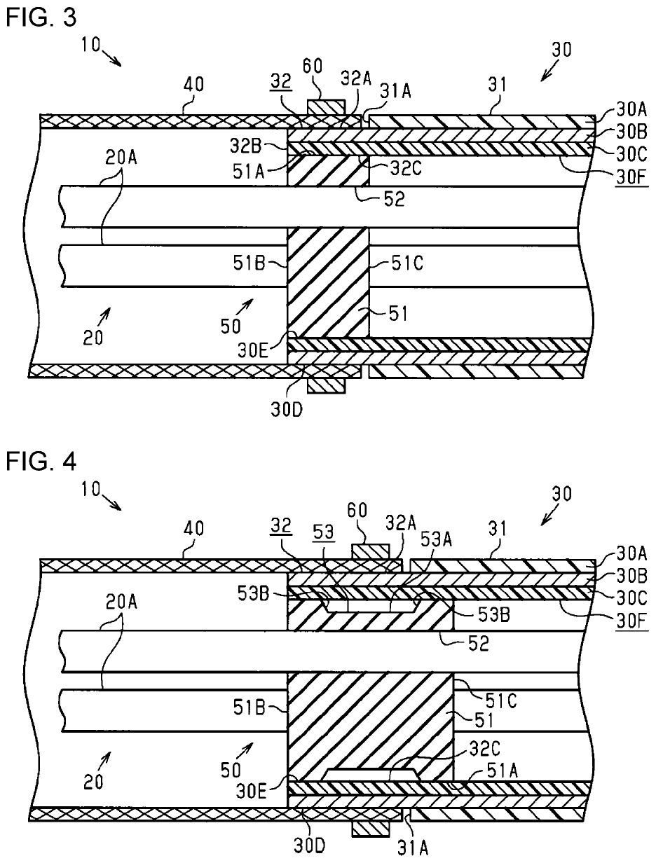

Examples of the material of the fitting member 50 include an elastic material. Examples of the elastic material include rubber. The fitting member 50 includes a main body 51, and a plurality of insertion holes 52 through which the electric wires 20 can be respectively inserted. The plurality of insertion holes 52 are formed in the main body 51, and extend in the longitudinal direction of the pipe 30 through the main body 51. The number of plurality of insertion holes 52 matches, for example, the number of electric wires 20. The fitting member 50 is fitted into the connecting portion 32, for example, so as to block an opening 30E of the pipe 30. For example, an outer circumferential face 51A of the fitting member 50 is in contact with the entire inner circumferential face 30F of the pipe 30 in the circumferential direction of the pipe 30, within the range in which the main body 51 is arranged inside the pipe 30 (see FIG. 3). The inner circumferential face 30F of the pipe 30 is constituted by the inner circumferential face of the inner layer 30C.

Examples of the material of the fastening member 60 include a metal material. Examples of the fastening member 60 include a crimping ring. The fastening member 60 fastens the braided member 40 to the outer circumferential face 32A of the connecting portion 32, in the region, of the pipe 30, in which the fitting member 50 is provided. For example, the fastening member 60 is attached to the braided member 40 so as to hold the braided member 40 between the fastening member 60 and the connecting portion 32. The fastening member 60 is crimped with the application of pressure using a tool or the like, and tightens the braided member 40, thereby fastening the connecting portion 32 and the braided member 40 to each other. With this process, the pipe 30 and the braided member 40 are fastened to each other by the fastening member 60, and an electrically conductive state is established between the pipe 30 and the braided member 40.

FIG. 3 shows a cross-section along the longitudinal direction of the wire harness 10. The fitting member 50 is fitted into the connecting portion 32, for example, such that an end face 51B of the main body 51 on the braided member 40 side (i.e., an end face oriented not in the inner side but in the outer side of the pipe 30) is arranged on substantially the same plane as an end face 32B of the connecting portion 32. The length of the fitting member 50 in the longitudinal direction of the pipe 30 is, for example, substantially the same as the length of the connecting portion 32 in the longitudinal direction of the pipe 30. The connecting portion 32 includes the entire region of the pipe 30 in which the fitting member 50 is provided. For example, the outer circumferential face 51A of the fitting member 50 is in contact with the entire inner circumferential face 32C of the connecting portion 32.

Hereinafter, an example of a procedure for arranging the wire harness 10 will be described with respect to FIGS. 1 to 3.

The wire harness 10 is arranged in the vehicle C, for example, in the following arrangement procedure. In the first step, the electric wires 20 are inserted through the pipe 30 such that the drawn-out portions 20A of the electric wires 20 are drawn out from the pipe 30. In the first step, the length of the drawn-out portions 20A that are drawn out from the pipe 30 (hereinafter, referred to as a “drawn-out length”) is set to a predetermined drawn-out length according to a distance between the end face 32B of the connecting portion 32 and the object device. In the second step, the electric wires 20 are respectively inserted through the insertion holes 52 of the fitting member 50, and the fitting member 50 is fitted into the connecting portion 32.

In the third step, the braided member 40 is attached to the connecting portion 32 so as to cover the drawn-out portions 20A, and the fastening member 60 is attached to the braided member 40 so as to hold the braided member 40 between the fastening member 60 and the connecting portion 32. In the fourth step, the fastening member 60 is crimped with the application of pressure using a tool or the like, and thus the pipe 30 and the braided member 40 are fastened to each other. With the application of pressure using a tool or the like in the fourth step, high pressure applied to the fastening member 60 acts on the connecting portion 32. Meanwhile, since the connecting portion 32 is supported by the fitting member 50 fitted into the connecting portion 32, even when high pressure is applied to the fastening member 60, the connecting portion 32 is unlikely to be deformed. Accordingly, it is possible to firmly fasten the pipe 30 and the braided member 40 to each other.

In the fifth step, in order to arrange the wire harness 10 under a floor of the vehicle C, the wire harness 10 is bent (see FIG. 1). In the sixth step, the terminals 21 of the electric wires 20 are connected to the object device. With the above-described procedure, the wire harness 10 is arranged in the vehicle C.

According to the wire harness 10 of the first embodiment, the following effects are achieved.

(1) In the wire harness 10, the fitting member 50 is fitted into the connecting portion 32 of the pipe 30, and the fastening member 60 is crimped with the application of pressure using a tool or the like, and thus the pipe 30 and the braided member 40 are fastened to each other. With this configuration, the connecting portion 32 subjected to the pressure applied to the fastening member 60 is supported by the fitting member 50, and thus, even when high pressure is applied to the fastening member 60, the risk that the connecting portion 32 will be deformed is lowered. Accordingly, it is possible to firmly fasten the pipe 30 and the braided member 40 to each other.

(2) The fitting member 50 is fitted into the connecting portion 32 so as to block the opening 30E of the pipe 30. With this configuration, the connecting portion 32 subjected to the pressure applied to the fastening member 60 is supported by the fitting member 50 in a dispersed manner in the circumferential direction of the pipe 30, and thus the risk that the connecting portion 32 will be deformed is further lowered. Accordingly, it is possible to more firmly fasten the pipe 30 and the braided member 40 to each other. Furthermore, since the fitting member 50 blocks the opening 30E of the pipe 30, the risk that water or the like will enter the pipe 30 is lowered. Accordingly, the wire harness 10 can be formed in such a way that a grommet or the like for improving the sealing properties of the pipe 30 has been omitted.

(3) The inner circumferential face 30F of the pipe 30 is constituted by the inner circumferential face of the inner layer 30C that is made of a resin material. With this configuration, when the inner circumferential face 30F of the pipe 30 and the electric wires 20 firmly come into contact with each other, the electric wires 20 are unlikely to deteriorate.

(4) The pipe 30 includes the outer layer 30A that is made of a resin material. Accordingly, even when flying rocks come into contact with the wire harness 10 during driving of the vehicle C, the wire harness 10 are unlikely to deteriorate.

(5) The fastening member 60 holds the braided member 40 between the fastening member 60 and the connecting portion 32, and fastens the pipe 30 and the braided member 40 to each other. The connecting portion 32 is a portion in which the outer layer 30A is stripped off to expose the intermediate layer 30B. With this configuration, the fastening member 60 is unlikely to project from the pipe main body 31 in the radial direction of the pipe 30, and thus the size of the wire harness 10 in the radial direction of the pipe 30 is made small. Meanwhile, when the outer layer 30A is stripped off, the strength of the connecting portion 32 decreases, and thus the risk of deformation when high pressure is applied to the fastening member 60 increases. In consideration of this aspect, the wire harness 10 employs a configuration in which the connecting portion 32 subjected to the pressure applied to the fastening member 60 is supported by the fitting member 50. Therefore, it is possible to keep the size of the wire harness 10 small, and to firmly fasten the pipe 30 and the braided member 40 to each other.

(6) In order to arrange the wire harness 10 under a floor of the vehicle C, the wire harness 10 is bent. Since the wire harness 10 is bent, the force that pulls the electric wires 20 into the pipe 30 acts. Meanwhile, the pressure applied to the fastening member 60 acts via the connecting portion 32 on the fitting member 50. Accordingly, the electric wires 20 inserted through the insertion holes 52 of the fitting member 50 are held by the fitting member 50, and movement of the electric wires 20 in the longitudinal direction of the pipe 30 is suppressed. Accordingly, the risk that the drawn-out length will change due to bending of the wire harness 10 is lowered. Thus, a change in the drawn-out length can be suppressed, and the level of precision in dimensions can be kept high.

### Second Embodiment

The wire harness 10 of the second embodiment has a configuration that is different from that of the wire harness 10 of the first embodiment in terms of the following aspects, and is substantially the same as that of the wire harness 10 of the first embodiment in terms of the other aspects.

As shown in FIG. 4, the fitting member 50 in the wire harness 10 of the second embodiment further includes a groove 53 that is formed on the outer circumferential face 51A of the main body 51. The groove 53 extends in the circumferential direction of the pipe 30. The groove 53 when viewed in a cross-section along the radial direction of the pipe 30 is, for example, in the shape of a circle or substantially in the shape of a circle. The groove 53 includes a bottom face 53A and a pair of side faces 53B. The pair of side faces 53B are, for example, inclined relative to the bottom face 53A. For example, an angle formed by the bottom face 53A and each of the side faces 53B is an obtuse angle. The depth of the groove 53 is, for example, substantially the same as the thickness of each of the layers 30A to 30C of the pipe 30.

The fitting member 50 is fitted into the connecting portion 32, for example, such that the end face 51B of the main body 51 is arranged on substantially the same plane as the end face 32B of the connecting portion 32. The length of the fitting member 50 in the longitudinal direction of the pipe 30 is, for example, longer than the length of the connecting portion 32 in the longitudinal direction of the pipe 30. In a state in which the fitting member 50 is fitted into the connecting portion 32, one of the side faces 53B of the groove 53 faces the connecting portion 32, and the other side face 53B of the groove 53 faces, for example, the pipe main body 31. The fastening member 60 is attached to the braided member 40 so as to hold the braided member 40 between the fastening member 60 and the portion, of the pipe 30, corresponding to the groove 53 in the region in which the fitting member 50 is provided. For example, the fastening member 60 is attached to the braided member 40 so as to be arranged within the width region in which the groove 53 is formed, in the connecting portion 32 of the pipe 30.

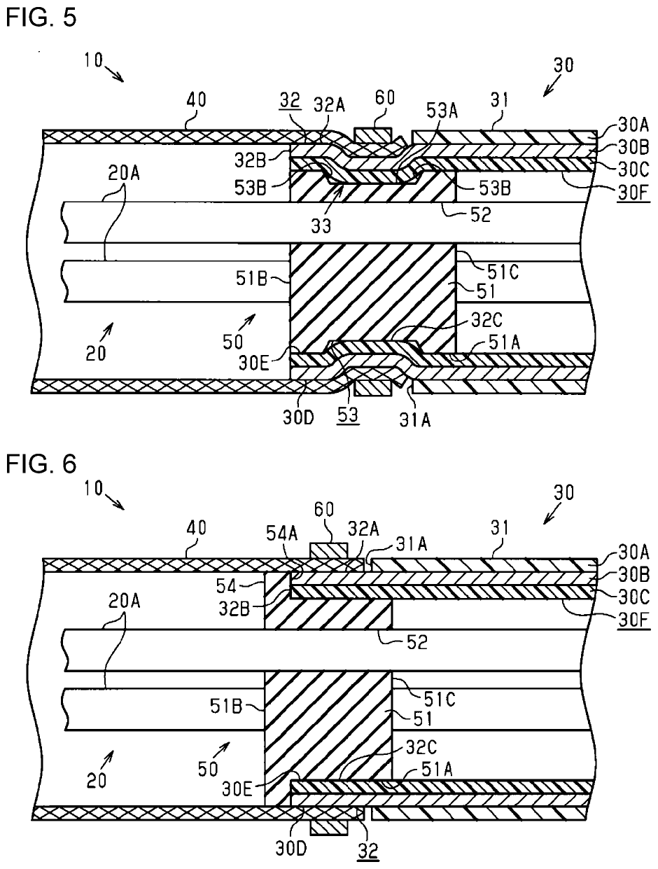

As shown in FIG. 5, the fastening member 60 is crimped with the application of pressure using a tool or the like, and tightens the braided member 40, thereby deforming the connecting portion 32. When the connecting portion 32 is deformed, a reduced diameter portion 33 is formed in a portion, of the pipe 30, that is tightened by the fastening member 60. The reduced diameter portion 33 is a portion, of the pipe 30, in which the connecting portion 32 is deformed. The inner diameter of the reduced diameter portion 33 is smaller than the inner diameter of the pipe main body 31. The outer diameter of the reduced diameter portion 33 is smaller than the outer diameter of the pipe main body 31. Part of the reduced diameter portion 33 is formed so as to be accommodated in the groove 53. When part of the reduced diameter portion 33 is accommodated in the groove 53, and the reduced diameter portion 33 is supported by the bottom face 53A of the groove 53, and thus the connecting portion 32 and the braided member 40 are fastened to each other. With this process, the pipe 30 and the braided member 40 are fastened to each other by the fastening member 60, and an electrically conductive state is established between the pipe 30 and the braided member 40.

According to the wire harness 10 of the second embodiment, part of the reduced diameter portion 33 deformed by the pressure that acts on the connecting portion 32 is accommodated in the groove 53 and supported by the bottom face 53A, and thus it is possible to firmly fasten the pipe 30 and the braided member 40 to each other. Furthermore, since the fitting member 50 blocks the opening 30E of the pipe 30, and the connecting portion 32 and the bottom face 53A of the groove 53 are firmly in contact with each other throughout the circumferential direction of the pipe 30, the risk that water or the like will enter the pipe 30 is further lowered. Accordingly, the wire harness 10 can be formed in such a way that a grommet or the like for improving the sealing properties of the pipe 30 has been omitted. The wire harness 10 of the second embodiment can also achieve effects that are substantially the same as the effects (3) to (6) obtained in the first embodiment.

### Third Embodiment

The wire harness 10 of the third embodiment has a configuration that is different from that of the wire harness 10 of the first embodiment in terms of the following aspects, and is substantially the same as that of the wire harness 10 of the first embodiment in terms of the other aspects.

As shown in FIG. 6, the fitting member 50 in the wire harness 10 of the third embodiment further includes a restricting portion 54 for restricting movement of the main body 51 in the longitudinal direction of the pipe 30. The restricting portion 54 constitutes, for example, part of the end face 51B of the main body 51, and is provided on the main body 51 so as to project from the main body 51 in the radial direction of the pipe 30. The restricting portion 54 when viewed in a cross-section along the radial direction of the pipe 30 is, for example, in the shape of a circle or substantially in the shape of a circle. The restricting portion 54 includes a restricting face 54A that is in contact with the end face 32B of the connecting portion 32. The length of the restricting face 54A in the radial direction of the pipe 30 is, for example, substantially the same as the sum of the thicknesses of the intermediate layer 30B and the inner layer 30C of the pipe 30. When the fitting member 50 is fitted into the connecting portion 32, and the restricting face 54A is in contact with the end face 32B of the connecting portion 32, movement of the fitting member 50 in the longitudinal direction of the pipe 30 is restricted.

It is preferable that the fitting member 50 is such that, in the longitudinal direction of the pipe 30, the distance between an end face 51C of the main body 51 on the pipe main body 31 side (i.e., a face oriented not in the outer side but in the inner side of the pipe 30) and the restricting face 54A is substantially the same as the length of the connecting portion 32 or is longer than the length of the connecting portion 32. In the example shown in FIG. 6, the fitting member 50 is such that, in the longitudinal direction of the pipe 30, the distance between the end face 51C of the main body 51 on the pipe main body 31 side and the restricting face 54A is longer than the length of the connecting portion 32.

According to the wire harness 10 of the third embodiment, movement of the fitting member 50 in the longitudinal direction of the pipe 30 is restricted by the restricting portion 54, and thus it is possible to properly determine the position of the fitting member 50 with respect to the connecting portion 32. Accordingly, the pipe 30 and the braided member 40 are properly fastened to each other by the fastening member 60. The wire harness 10 of the third embodiment can also achieve effects that are substantially the same as the effects (1) to (6) obtained in the first embodiment.

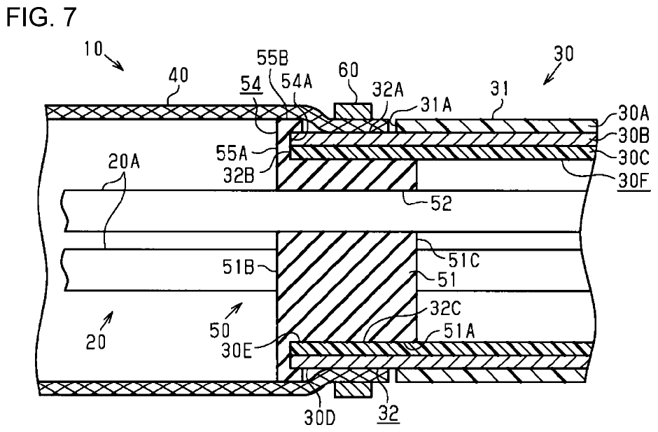

The above description of the embodiments shows merely exemplary forms that the wire harness according to the preferred embodiments may take, and is not intended to limit the invention to the exemplary forms. The present invention may take forms other than the above-described embodiments, including, for example, the following modifications of the embodiments, and forms in which at least two modifications that are not mutually inconsistent are combined.
The configuration of the restricting portion 54 in the third embodiment may be freely changed. In the example shown in FIG. 7, the restricting portion 54 includes a first portion 55A and a second portion 55B. The first portion 55A constitutes, for example, part of the end face 51B of the main body 51, and is provided on the main body 51 so as to project from the main body 51 in the radial direction of the pipe 30. The first portion 55A includes the restricting face 54A. The second portion 55B projects from the first portion 55A, for example, so as to cover the outer circumferential face 32A of the connecting portion 32. When the fitting member 50 is fitted into the connecting portion 32, and the restricting face 54A is in contact with the end face 32B of the connecting portion 32, movement of the fitting member 50 in the longitudinal direction of the pipe 30 is restricted. Furthermore, in a state in which the fitting member 50 is fitted into the connecting portion 32, part of the connecting portion 32 is covered by the restricting portion 54, and thus the sealing properties of the pipe 30 further increase.
The relationship between the outer circumferential face 51A of the fitting member 50 and the inner circumferential face 30F of the pipe 30 may be freely changed. For example, the outer circumferential face 51A of the fitting member 50 is in contact with part of the inner circumferential face 30F of the pipe 30 in the circumferential direction of the pipe 30, within the range in which the main body 51 is arranged inside the pipe 30. According to this example, in a state in which the fitting member 50 is fitted into the connecting portion 32, part of the opening 30E of the pipe 30 opens.
The material of the fitting member 50 may be freely changed. In one example, the material of the fitting member 50 is a resin material.
The number of insertion holes 52 may be freely changed. In one example, the number of insertion holes 52 is one. According to this example, the electric wires 20 are inserted through the one insertion hole 52.
The configuration of the connecting portion 32 may be freely changed. In one example, the connecting portion 32 is such that the outer layer 30A is stripped off such that part of the outer layer 30A remains on the end face 32B side on the outer circumferential face of the intermediate layer 30B. According to this example, the outer circumferential face 32A of the connecting portion 32 is constituted by the outer circumferential face of the outer layer 30A and the outer circumferential face of the intermediate layer 30B.
The pipe 30 may be formed in such a way that the outer layer 30A has been omitted. Also, the pipe 30 may have a layer structure including four or more layers.

The number of electric wires 20 may be freely changed. In one example, the number of electric wires 20 is one, two, or four or more.

It will be appreciated by those skilled in the art that the present invention may be embodied in other specific modes without departing from the technical idea thereof. For example, some of constituent elements described in the embodiment (or one or a plurality modes thereof) may be omitted or combined. The scope of the invention is to be determined by reference to the claims along with the full range of equivalents to which such claims are entitled.

### LIST OF REFERENCE NUMERALS

10 Wire harness

20 Electric wire

20A Drawn-out portion

30 Pipe

30A Outer layer (first layer)

30B Intermediate layer (second layer)

30C Inner layer (third layer)

30E Opening

32B End face

33 Reduced diameter portion

40 Braided member

50 Fitting member

51 Main body

51A Outer circumferential face

52 Insertion hole

53 Groove

54 Restricting portion

60 Fastening member

1. A wire harness comprising:
a pipe including a first layer that is made of a resin material, and a second layer that is made of a metal material and is provided on an outer side of the first layer;
electric wires inserted through the pipe;
a braided member that is formed by braiding a plurality of metal element wires, and is attached to the pipe so as to cover drawn-out portions of the electric wires that are drawn out from the pipe;
a fitting that is fitted into the pipe and includes an insertion hole through which the electric wires can be inserted; and
a fastener, in a region of the pipe in which the fitting member is provided, the braided member to an outer circumferential face of the second layer,
wherein the fitting further includes a main body through which the insertion hole is formed, and a groove that is formed on an outer circumferential face of the main body and extends in a circumferential direction of the pipe,
the fastener is, in a region of the pipe in which the fitting is provided, arranged within a width region in which the groove is formed, and
a reduced diameter portion is formed in a portion of the pipe that is tightened by the fastener, and part of the reduced diameter portion is formed so as to be accommodated in the groove.

2. The wire harness according to claim 1, wherein the fitting member is fitted into the pipe so as to block an opening of the pipe.

3. The wire harness according to claim 1, wherein the pipe further includes a third layer that is made of a resin material and is provided on an outer side of the second layer.

4.-6. (canceled)

7. The wire harness according to claim 1, wherein the fitting further includes a main body through which the insertion hole is formed, and a restricting portion that is provided on the main body and is in contact with an end face of the pipe, thereby restricting movement of the main body in a longitudinal direction of the pipe.
